(19) United States
(12) Patent Application Publication
(10) Pub. No.: US 2002/0094870 A1
(43) Pub. Date: Jul. 18, 2002

(54) Database driven electronic game

(76) Inventor: Kenneth C. Murray, Erdenheim, PA (US)

Correspondence Address: KENNETH CHARLES MURRAY, 10 WHITEMARSH AVENUE, Erdenheim, PA, 19038, US

(21) Appl. No.: 10/029,325

(22) Filed: Dec. 20, 2001

Related U.S. Application Data
(60) Provisional application No. 60/256,949, filed on Dec. 21, 2000.

(51) Int. Cl. G06F 19/00

(52) U.S. Cl. 463/42

(57) ABSTRACT

A database driven electronic game comprising a plurality of remotely located players utilizing the Internet to access a host web site. The game is database driven by game administrator servers utilizing an application service provider model. To win the game teams must build the largest team in terms of numbers of players. If your team has the most team members at the end of the specified game time period, your team wins. The game administrator servers record all player entries, record the creation of teams, confirms the email address of all players, measures all teams in terms of number of team members and identifies the largest team as the winner.

The method of the game provides a database administrator servers to record all game activities and record the specified game time period. The servers generate the email templates needed to invite additional players to participate as well as the servers notifies all players of the game's conclusion via email and indicates to all players which team wins the game.

The electronic game encourages data collection, delivers advertising and increases page views and visitors to the host web site.

### BACKGROUND

1. Field of the Invention

The present invention broadly relates to the field of electronic commerce and to electronic mail, and more specifically, to an electronic mail game that facilitates advertising, data collection, and page view creation.

2. Background of the Invention

By the end of year 2000, industry analysts estimate that about half of the U.S. population will have access to the Internet, as compared to only 10% four years ago. The analysts expect this explosive growth in online population to continue, projecting that 70-75% of the U.S. population will be online by 2003. To a large extent, users are attracted to the Internet by the ability to browse rich information content and to access providers of products and services. In turn, Internet merchants and content providers are eager to capture the attention and wallets of as many of the increasing online users as possible. Thus, the merchants and content providers are constantly searching for new and effective ways to connect with online users.

Some of the typical ways in which merchants and content providers reach out to online users include banner advertisements, click-through links to associate web sites, and advertisements in other media, such as television and magazines, which direct consumers to a particular web site. These advertising methods aim to influence the web surfing habits of online users. However, although these advertisements may occasionally steer a user to a particular site, most often users simply ignore the advertisements and continue browsing for the information they are seeking.

Besides advertisements pushed during browsing sessions, advertisers, merchants, and content providers have a potentially more powerful means for reaching consumers, namely through electronic mail (or “email”). In fact, according to a Nov. 20, 2000 article entitled “Email Outpaces the Web” in The Standard, 94% of American adults online access their email at least once a month, while only 89% surf the web at least once a month. In addition, industry analysts estimate that, in the year 2000, online users will send approximately 10 billion nonspam email messages per day. This volume far exceeds the 3 billion messages per day sent in 1998. Indeed, by 2005, users will send an estimated 35 billion email messages per day. Overall, estimates from industry analysts suggest that today somewhere between 452 million and 569 million email accounts exist. As more people go online and as manufacturers add email capabilities to wireless devices, the popularity of email will undoubtedly continue to expand.

Thus far, advertisers, merchants, and content providers have used email advertisement in only limited ways. For example, perhaps the most annoying and uncreative method is spamming, in which a sender emails copies of the same message to large numbers of newsgroups or users on the Internet, to advertise products or broadcast some political or social commentary. Usually, however, because most online users are familiar with such tactics, the users delete these messages without even opening them.

As another example of email advertising, some merchants or content providers ask users for permission to push email advertisements to them from time to time, under certain conditions. These subscription-type services record the interests of the subscribing users and send only messages relevant to those interests. In addition, the messages typically include instructions on how to unsubscribe, should the user grow tired of receiving them. Overall, because these email advertisements are somewhat tailored to user interest, they do offer some degree of advertising value. However, the user must always initiate the process by first visiting the sponsoring web site and then agreeing to receive the pushed email advertisements. Thus, advertisers are limited to reaching only those consumers who express interest, and can not spark new business from new consumers.

Another example of email advertising delivers advertising content as a part of the background of a primary email service. Examples of these primary email services include electronic greeting cards, screen savers, and free email services. In the electronic greeting card example, a sender creates a card on a sponsor web site and sends the card to a recipient. The recipient receives the email, opens it, and views the electronic greeting card. Advertisements are often integrated with the card or appear in the background of the email message. In addition, some electronic greeting card services require recipients to provide brief demographic information before they can view the greeting card. Although this type of email advertising can reach new potential consumers and can gather some marketing information, the method is limited by the inherent point-to-point communication. In other words, each email message reaches only one potential consumer. Moreover, because the message is typically personalized for that recipient, the sender would rarely forward the message to more than one person. Thus, an advertiser's reach is necessarily restricted.

The present invention addresses the needs of advertisers, merchants, and content providers in reaching large numbers of new potential consumers through the Internet. The present invention capitalizes on the popularity of electronic mail and introduces a unique gaming element that encourages the widespread dissemination of advertising and the efficient gathering of valuable marketing data.

Thus far, Internet games have been limited to mimicking traditional games, such as card games like Poker and Blackjack, and board games like chess and Othello. The Internet games support single player and multiple player competition. In the multiple player competition, players compete against each other. Examples of web sites that operate these types of games include Gamesville.com, Uproar.com, Boxerjam.com, pogo.com, hotgamesite.com, hotprize.com, imustlotto.com, freelotto.com, iwin.com, iwon.com, and eprize.com. Although these sites may generate some consumer loyalty and encourage return visits, users of the site must initiate contact to play a game, and, furthermore, must click-through any advertisements presented on a web site in order for an advertiser to truly reach a consumer. As mentioned above for advertisements pushed during browsing sessions, historically, the percentage of users who click through these advertisements is relatively low. Thus, again, the advertisers, merchants, and content providers fail to reach a large pool of potential customers.

### SUMMARY OF THE INVENTION

The present invention is an electronic mail game that facilitates the widespread dissemination of advertising to new potential customers and the collection of valuable marketing data from those customers. As a part of the advertising, the present invention facilitates the creation of page views for host web sites. The game, which is sometimes referred to herein as “FastFriendz”, incorporates a powerful, viral marketing strategy into the friendly and unobtrusive environment of personal one-to-one communication. Potential new customers receive email advertisements from friends in the context of a game. In contrast to de-personalized spam messages and pushed advertisements, a recipient is receptive to a message because the recipient recognizes the sending address as a friend. Thus, the recipient is much more likely to open the email message, review the advertisement and/or host web page, learn about the game and its potential payout, and forward the email message to other friends in an effort to win the game. In addition, as a part of the game, sponsors can collect personal information from the recipients to amass valuable marketing data.

According to a representative embodiment of the present invention, the object of the email game is to create an email string that includes more enrolled members than any other email string formed during a specified period. (In this application and the attached materials, the email string is sometimes referred to as “FriendzString.”) To create an email string, a first player creates a team name and sends an email to one or more friends. The email includes, for example, instructions on how to play the game and on how to join the team. By joining, a recipient of the email becomes an enrolled member of the team. The newly enrolled member can then forward the email to additional friends to enlarge the email string and increase the number of enrolled members. The team with the most enrolled members at the end of the specified period (for example, a month) wins the game.

As an incentive to play the game, a representative embodiment of the present invention provides prizes for the enrolled members of the winning team and does not charge participants to play the game. Preferably, a sponsor of the game furnishes the prizes. In return, the sponsor can include advertising content or links to advertising within the emails sent by enrolled members. The sponsor can also integrate survey questions into the enrollment process to gather information about the members, such as marketing information and email addresses. In addition, the sponsor can run a game of the present invention through its own host web site so that, for example, the sponsor can present its own content peripheral to the game.

According to a representative embodiment of the present invention, each game has only one sponsor, which offers one set of prizes to the winning team members. Players can join only one team per game. However, multiple games can take place concurrently, allowing players to join a team for each game.

Each sponsor provides revenue for a game administrator, for example, by paying a set amount to sponsor a game, by paying an advertising fee for each advertisement viewed, or by paying a percentage of sales derived from advertisements shown through the game.

The game administrator provides the system that supports the email game. This game administrator is sometimes referred to in this specification and the attached materials as “FastFriendz.” The system facilitates the forming of teams, the creation of emails, the integration of sponsor information into the emails, the gathering and storing of information from enrolled members, the monitoring of game standings and final results, and the reporting of the winning team to enrolled members. Preferably, the system includes a web site that players can visit to check game standings and to learn of other games that they can enter. In addition, the game administrator sends an email to all enrolled members of all teams at the conclusion of a game to announce the winning team. This final announcement provides another opportunity to push advertising content to the enrolled members.

Thus, the present invention provides an entertaining game that attracts players and encourages repeat visits to a host web site and to a central game administrator web site. Capitalizing on this player interest, the present invention also provides valuable advertising and collects useful player information. Sponsors can compile the player information into beneficial marketing data that can further drive the advertising, for example, by targeting the advertising to particular interests of the players.

Accordingly, an object of the present invention is to provide an entertaining game that attracts many players.

Another object of the present invention is to attract customers to host web sites.

Another object of the present invention is to facilitate the widespread dissemination of advertising.

Another object of the present invention is to gather valuable marketing information.

Another object of the present invention is to increase the likelihood that a recipient of an email advertisement will open the email and view the advertisement.

These and other objects, aspects, and advantages of the present invention are described in greater detail in the detailed description of the invention and the attached materials. Additional features and advantages of the invention will be set forth in the description that follows, will be apparent from the description, or may be learned by practicing the invention.

### BRIEF DESCRIPTION OF THE DRAWINGS

FIG. 1 is a schematic diagram showing the system architecture of a representative embodiment of the present invention.

FIG. 2 is a key describing the annotations used to label the slides that illustrate the screen images of a representative embodiment of the present invention.

FIGS. 3-17 are screen images illustrating a representative embodiment of the system and web site operation of the present invention, which implements an email game.

### DETAILED DESCRIPTION

In a representative embodiment, the system and method of the present invention provide an email game that facilitates advertising, data collection, and page view creation. The email game encourages players to send emails to friends, who are in turn encouraged to send emails to their friends, and so on. This process creates a viral marketing platform through which advertisers can efficiently push advertisements and collect market data. In describing the present invention, the following sections outline representative embodiments of the game rules, system architecture, and system and web site operation.

### Game Rules

The object of the game is to build an email string having more enrolled members than any other email string of the same game. An enrolled member is defined by a name of a person and the person's email address. A person can enroll only once, regardless of the number of email addresses the person possesses. The enrolled members of an email string make up a team. To create a team, a first player visits the web site of the game administrator or the sponsor and clicks through a link for creating a team. In the case of a web site of the game administrator, the player clicks through a button or icon marked for creating a team. For a sponsor web site, the player clicks through a special game icon, such as a FastFriendz icon.

After the first player has chosen to create a team, the system prompts the player for information necessary to establish a team account, such as a team name and the name and email address of the first player. Once the team is established, the first player can forward an email to friends, asking the friends to join the team and to recruit more enrolled members by forwarding the email to more potential players.

When a potential player receives an email from an enrolled member of a team, the potential player joins the team by clicking through a link in the email, or by visiting the web site of the game administrator or the sponsor and searching for the team or email string that the player would like to join. To join through an email, each email contains a link that adds the new player to the team of the enrolled member who sent the email. To join through the web site of the game administrator or sponsor, the web sites include a search function to find the desired team and an enrollment function that adds the new player to the desired team.

To properly administer a game and ensure fairness to all participants, a game administrator can apply specific rules to each implementation. As one of ordinary skill in the art would appreciate, these specific rules will vary according to the particular circumstances of a game administrator or sponsor. However, to illustrate a representative implementation of the game, the following list describes rules that could be applied:

All players must have a valid email address and must be 18 years or older.

A player can enroll in no more than one team per game.

A player can enroll in a team only once, using a name and only one email address.

Upon enrollment, the player agrees to receive one email from the game administrator at the conclusion of the game, which indicates the winning team.

Fabricating an email address to create additional enrolled team members results in disqualification for the entire team.

Winners are notified by email.

To claim a prize, each enrolled member of the winning team must provide additional survey information.

The sponsor of each game determines the game deadline, and all team members must enroll before that deadline.

There is no cost for players to enter the contest.

A player must maintain the valid email address that the player used to enroll in the game through the end of the game deadline, and for a period of three months after the game for verification (e.g., to verify receipt of the prize).

If a player changes his email address, he is disqualified from the contest.

Any attempt to fabricate entries or to create a program that automatically generates entries will result in the disqualification of the infringing team and the permanent barring of the members of the team from any future games.

No player may use the email game for commercial solicitations or spamming email.

No telephone entries or written entries are accepted.

Players may return to the sponsor's host web site or to the web site of the game administrator to check their team's status.

Players are encouraged to invite multiple players to join the game.

Fulfillment of the prize is the responsibility of the host web site (sponsor) and is not the responsibility of game administrator.

By agreeing to play the game, players agree to receive a notification of winners by email from the game administrator. The notification also gives players the opportunity to access additional information about the sponsor and gives the sponsors the opportunity to push more content to the players.

All players have the ability to opt out of any future email game correspondence.

### System Architecture

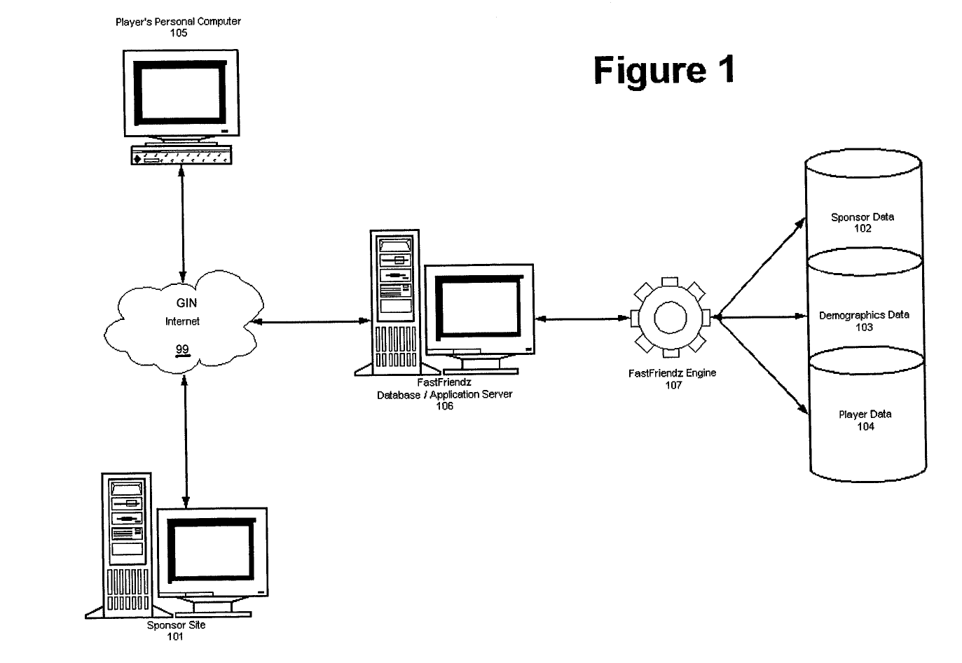

FIG. 1 illustrates a representative embodiment of the system architecture of the present invention, which is based on an application service provider (ASP) model. According to this ASP model, on the front end, a host web site 101 of the sponsor presents the game to a user (player), interfacing through a graphical user interface, for example. The player accesses host web site 101 using a personal computer 105 in communication with host web site 101 through a global information network 99, such as the Internet. In turn, host web site 101 is in communication with the game administrator server 106 through network 99. To configure a game on host web site 101, game administrator server 106 issues a username and password to host web site 101 to permit access to the administrative functions of server 106.

On the back end, game administrator server 106 executes game functions and administrative functions, and stores data associated with the game. In driving the game, server 106 performs functions such as serving contest pages, sending emails to players, generating encrypted uniform resource locators (URLs), listing all current contests accessible to the public, and restricting administrative access to the appropriate parties. A game administrator engine 107 executes these game functions. In addition, engine 107 manages data between a sponsor database 102, a demographics database 103, and a player database 104.

Sponsor database 102 stores information such as usernames and passwords of sponsors, names of sponsors, locations of sponsor banners, prize descriptions, contest termination dates, URLs for sponsor contest pages, font-style preferences, and background color preferences (or locations of background graphics).

Demographics database 103 stores information gathered as part of the game process. For example, a sponsor can integrate brief surveys into the enrollment process such that a player must answer questions to enroll in a team. The sponsor fashions these questions to satisfy the needs of the sponsor. For example, if the sponsor wishes to collect marketing data related to a product it sells, the survey questions could ask players to identify features that they desire on such a product. Game administrator server 106 stores these survey questions and the answers to these questions in demographics database 103.

Player database 104 stores information about players and enrolled members. Such information could include player names, player email addresses, team affiliations of players, and identifications of referring players (ie., the enrolled member who asked the player to join a team).

Although shown as discreet databases, one of ordinary skill in the art would appreciate that databases 102, 103, and 104 could be a single database. Databases 102, 103, and 104 could also be stored on server 106 or on distributed computers. In addition, although the representative embodiment describes an ASP model architecture having a sponsor site 101 and a separate server 106, one of ordinary skill in the art would also appreciate that the present invention could be implemented on a single physical computer as well.

According to the representative ASP model, a sponsor pays the game administrator for using the technology stored on server 106 and the information housed in databases 102, 103, and 104. Host web site 101 of the sponsor, therefore, does not need to host the technology and does not have to have a customized game built for it. This configuration minimizes costs for the participating sponsors and ensures that the game administrator has appropriate control over the coding required to create and manipulate the email game. Although an alternate embodiment could allow host web sites to own the game and store the game on their servers, this alternate configuration is not preferable because the game administrator loses the ability to control how the game is used or modified. Thus, the ASP model is preferable. Moreover, if an update to the game is necessary, a game administrator can make the appropriate changes at one central location, making the changes effective across all host web sites. This configuration reduces maintenance and assures that all host web sites have access to the most current and relevant game format.

### System and Web Site Operation

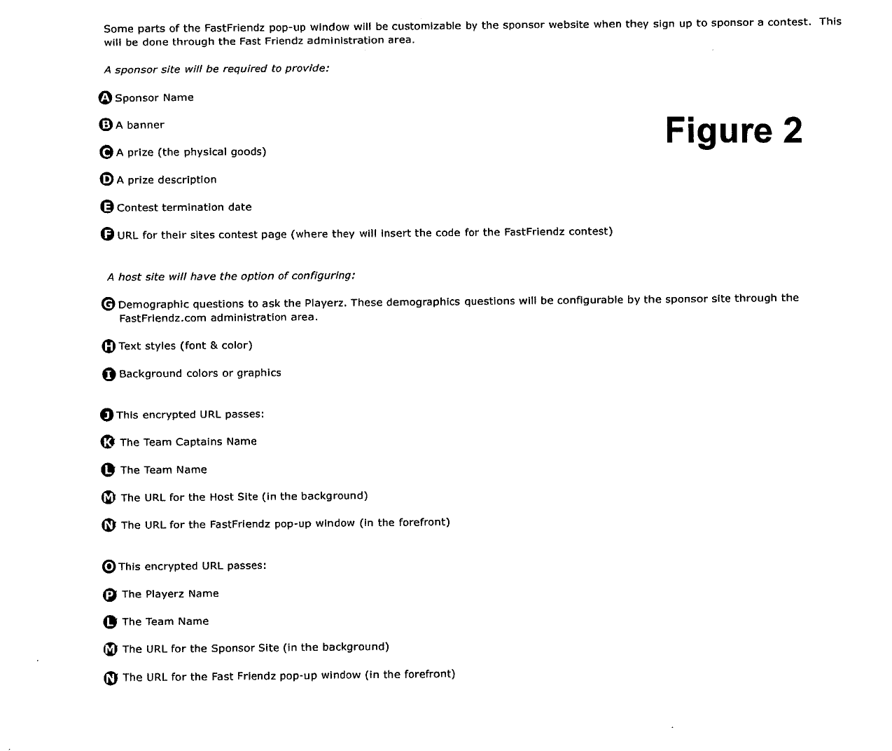

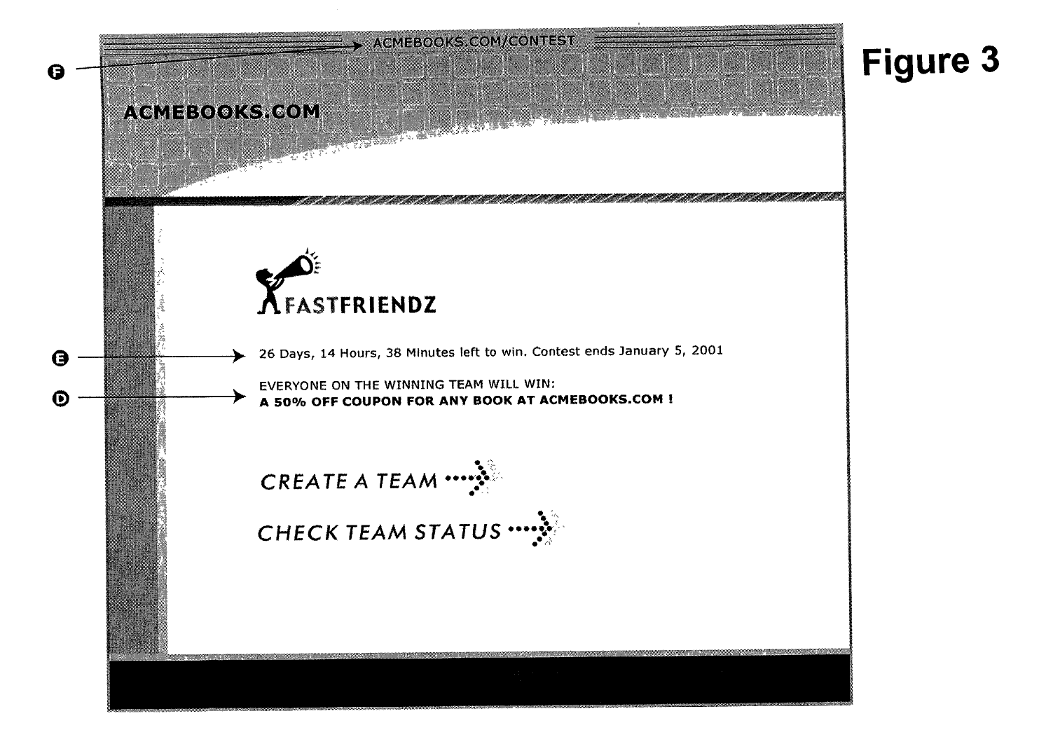

FIGS. 3-17 illustrate a representative embodiment of the game flow of the present invention, as viewed through representative screen images of a host web site. FIG. 2 provides a key that describes the annotations used to label FIGS. 3-17.

According to a representative embodiment of the present invention, the game flow of FIGS. 3-17 is initiated as follows. A sponsor contracts with the game administrator to host an email game for a specified duration and to offer a suitable prize for winning the game. The sponsor then advertises the game by, for example, posting advertising banners on the web sites of the World Wide Web. If a potential player responds to the advertisement by, for example, clicking through a banner advertisement, the potential player is taken to a pop-up window displayed on top of the home page or destination page of the host web site of the sponsor. The pop-up window asks the potential player if he or she would like to start a team or join an existing team. If the potential player chooses to play the game, the player is guided through the page views shown in FIGS. 3-17 (discussed below).

If the potential player chooses not to play, the pop-up window closes and the potential player is left on the host web site of the sponsor (rather than returning to the web site on which the potential player clicked through the banner advertisement). If the sponsor has agreed to pay the game administrator based on page views, even if the potential player chooses not to play, the refusal still counts as a download and a page view because the potential player is left on the host web site of the sponsor, where the sponsor has the chance to expose its products or services to a new potential customer.

As another method of initiating the game flow, if a potential player is already on a host web site of a sponsor, the potential player can click through a promotional banner or game icon. In response, a pop-up window appears over the host web site, with a solicitation to play the game. The game flow process then continues as shown in FIGS. 3-17 (discussed below).

As another method of initiating the game flow, a potential player can visit the web site of the game administrator (e.g., www.FastFriendz.com™) to learn what sponsors are hosting games. Through the game administrator web site, the potential player can choose a game and link directly to the host web site of the sponsor. A player can enter multiple concurrent games but can only enter any individual game once.

Assuming now that the game flow has been initiated, the system of the present invention presents the representative screen image shown in FIG. 3. This first page includes a brief description of the game (from a page of the game administrator) displayed on a page of the sponsor's host web site. The game administrator provides the administrative back end, through which the sponsor can upload graphics, prize descriptions, banners, contest termination dates, and URLs for their game page, and can configure questions to ask players.

On the first page, the brief game description can include information such as the prize offered by the sponsor and the deadline of the game. In this example, the prize is a discount coupon for purchases from the sponsor and the deadline is Jan. 5, 2001. The screen image of FIG. 3 also includes the uniform resource locator F for the contest (game) page of the host web site, which in this example is acmebooks.com/contest. The sponsor inserts the code for the email game in this URL.

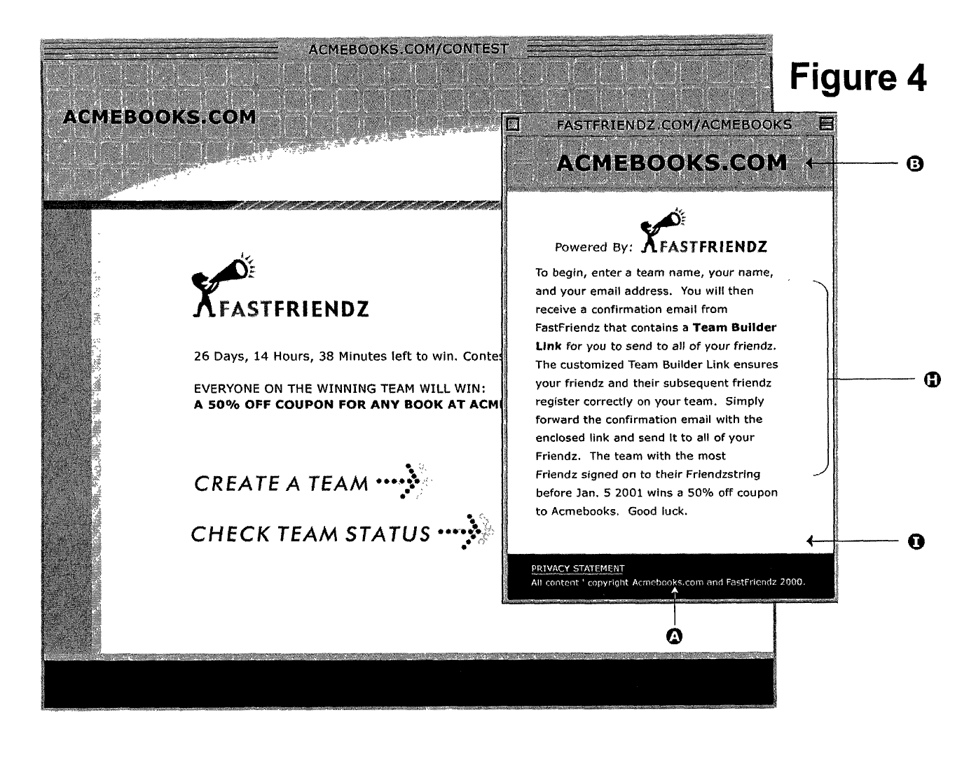

The screen image of FIG. 3 also provides a player with options for participating in the game, such as “create a team” and “check team status.” If the player is already enrolled in a team, the player can choose “check team status” to find out how many enrolled members the team has and how that number compares to other teams participating in the game. If the player is not already enrolled in a team, the player can choose “create a team,” in response to which the system displays the screen image shown in FIG. 4. A player who creates a team is sometimes referred to herein as a team captain.

The screen image of FIG. 4 includes a pop-up window that describes the game and provides the player with instructions on how to create a team and initiate an email string. The pop-up window includes the sponsor's name A and a banner B of the sponsor. The sponsor can configure the text styles H of the game description and the background color and/or graphics I of the pop-up window.

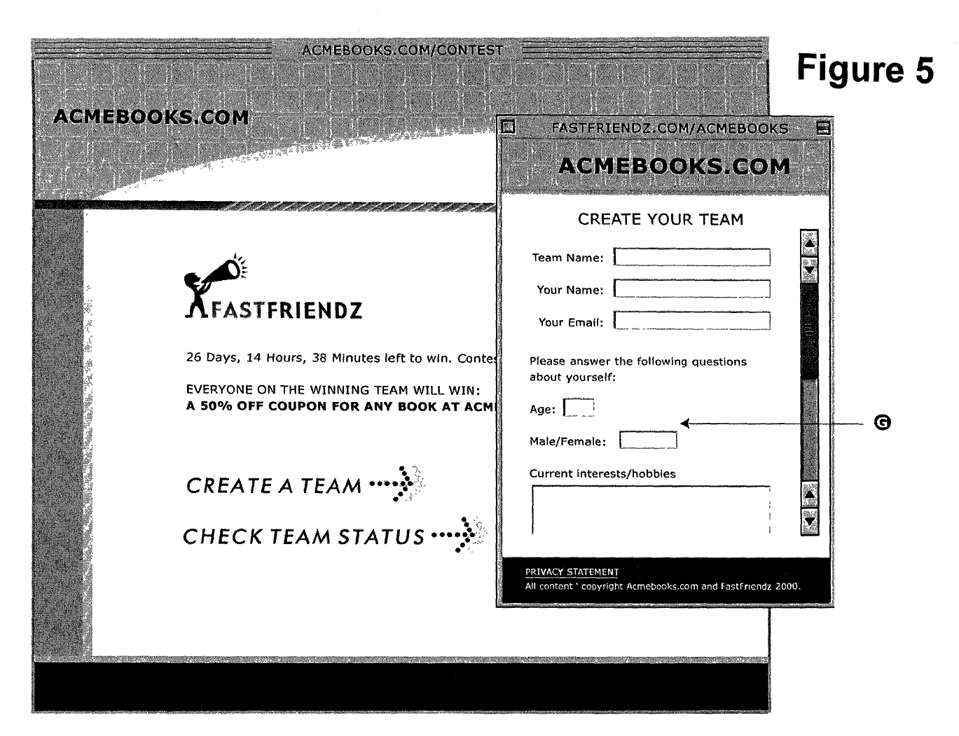

After clicking on the pop-up window of FIG. 4 or after a timeout period, the system displays the pop-up window shown in FIG. 5. This pop-up window prompts the player to enter information necessary to create a team, such as a team name, the name of the player, and the email address of the player. This pop-up window can also include demographics questions G, such as the age and gender of the player, and the player's current interests or hobbies. The sponsor can configure these demographics questions through the administrative functions of the game administrator server. The sponsor can fashion the questions to suit its individual needs.

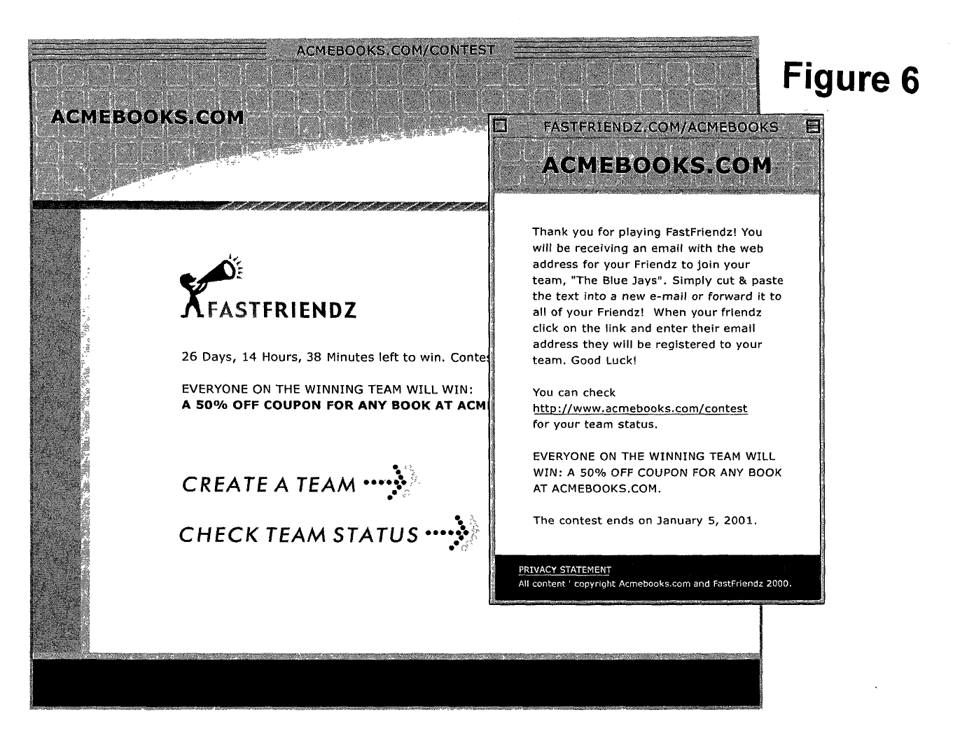

Once the player has entered the required information into the data fields, the system displays the pop-up window shown in FIG. 6. This pop-up window confirms the creation of the team and provides the team captain with further information about the game. For instance, the pop-up window can inform the team captain that the system will send an email with which the team captain can begin the email string. The pop-up window can also provide the URL at which to check team standings, and can reiterate the prize and the game deadline. At this point, the team captain can close the pop-up window, return to the web site of the sponsor, and continue browsing.

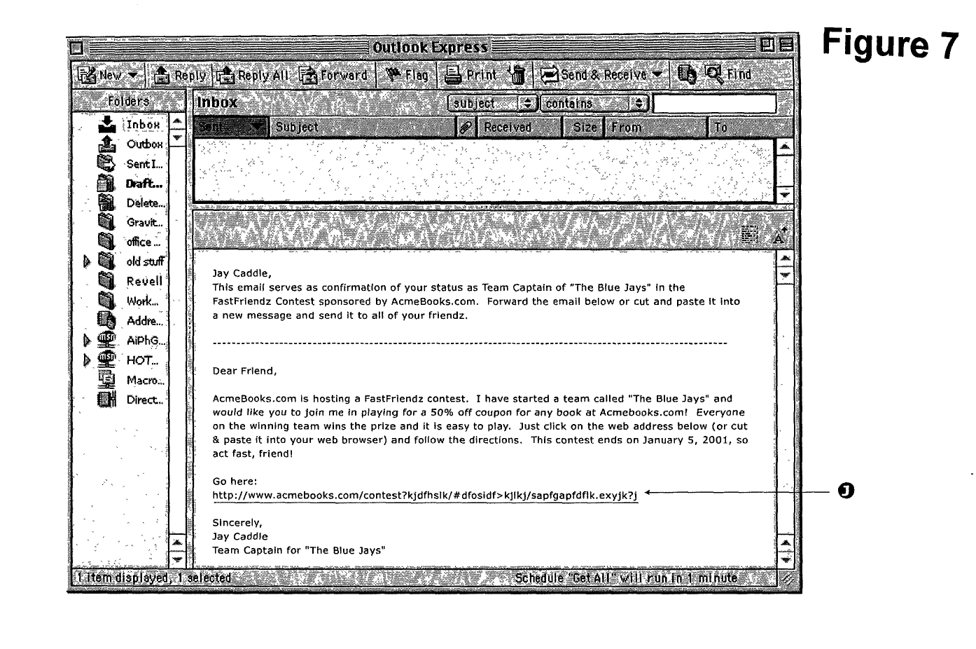

FIG. 7 shows the email sent by the system to the team captain. The email confirms the creation of the team (which is named “The Blue Jays” in this example) and the player's status as team captain. The email also includes instructions on how to begin the email string, and preferably includes a prepared email message that the team captain can readily forward to friends (potential players). The team captain can simply forward the prepared email message or can cut and paste the message into a new message. The prepared email message includes an encrypted uniform resource locator J that passes the name of the team captain, the team name, the URL for the host site (in the background), and the URL for the pop-up window of the game administrator (in the forefront).

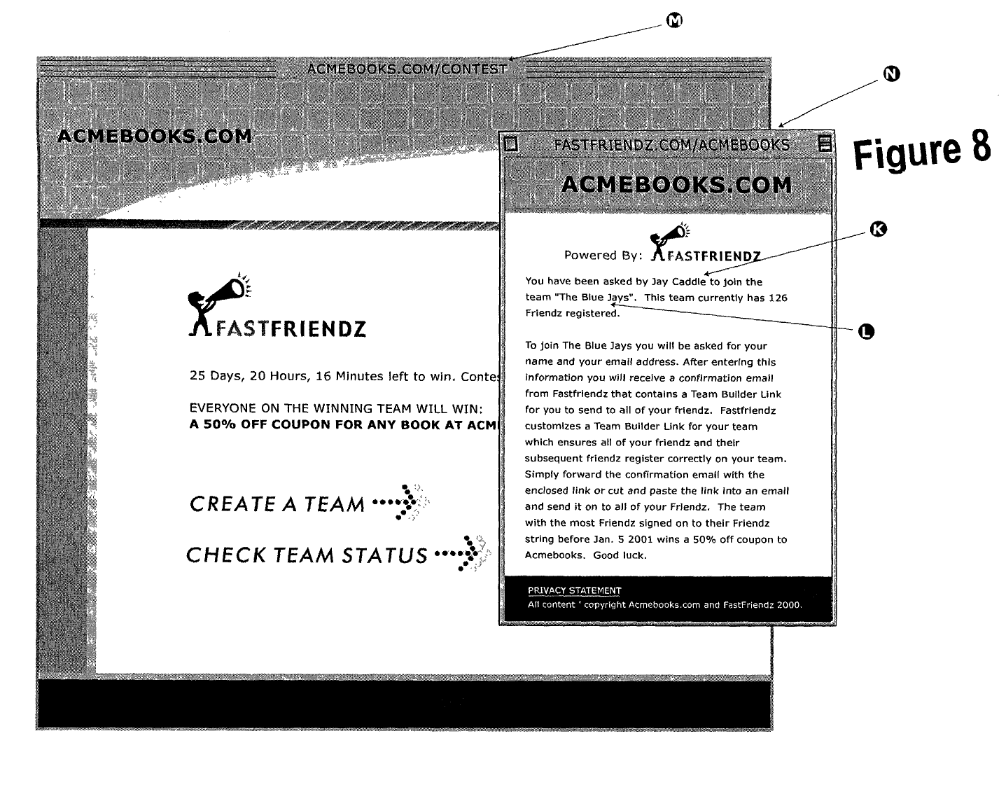

After the team captain forwards the email to a friend and the friend clicks on the encrypted URL in the message, the system opens the contest page of the sponsor web site in the background with the pop-up window of the game administrator in front, as shown in FIG. 8. The encrypted URL passes the information for these windows M and N, as well as the referring player's name K and the team name L, which in this example are Jay Caddle and The Blue Jays, respectively. The pop-window N provides the friend (potential player) with information about the team and the game. For example, the pop-up window provides the name of the team, the name of the referring player, the number of enrolled members on the team, and instructions on how to join the team and play the game.

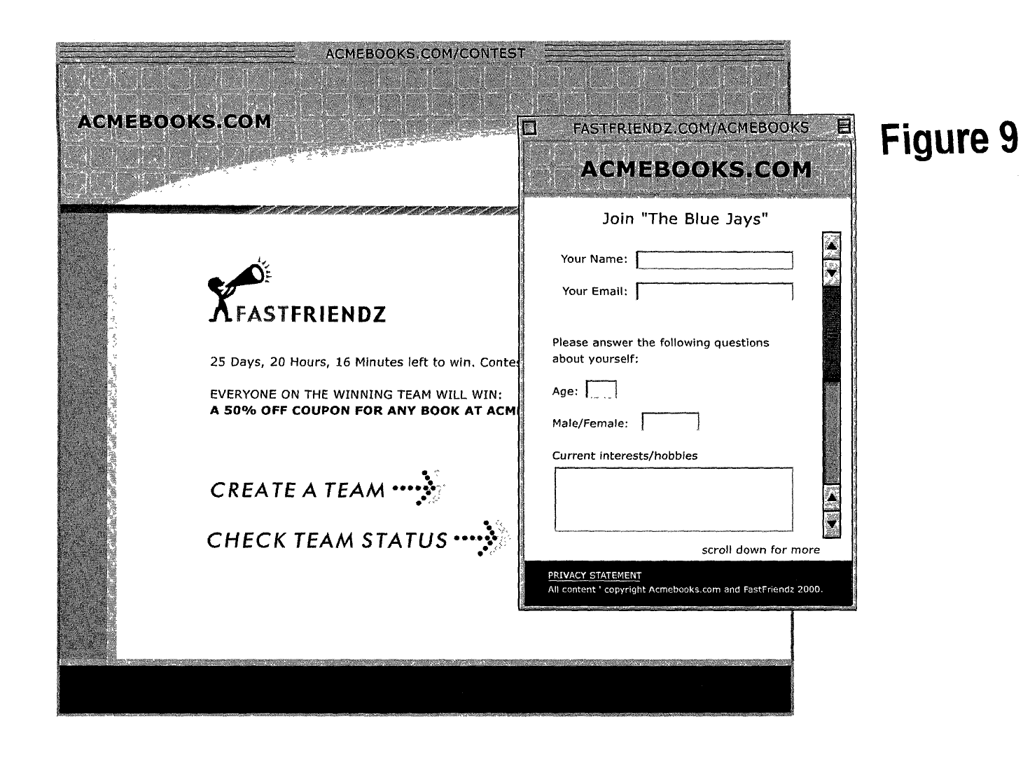

After the friend clicks on the pop-up window of FIG. 8 or after a timeout period, the system displays the pop-up window shown in FIG. 9. This pop-up window prompts the friend to enter information necessary to enroll in a team, such as the name and email address of the friend. Like the screen image of FIG. 5, this pop-up window can also include demographics questions, such as the age and gender of the player, and the player's current interests or hobbies.

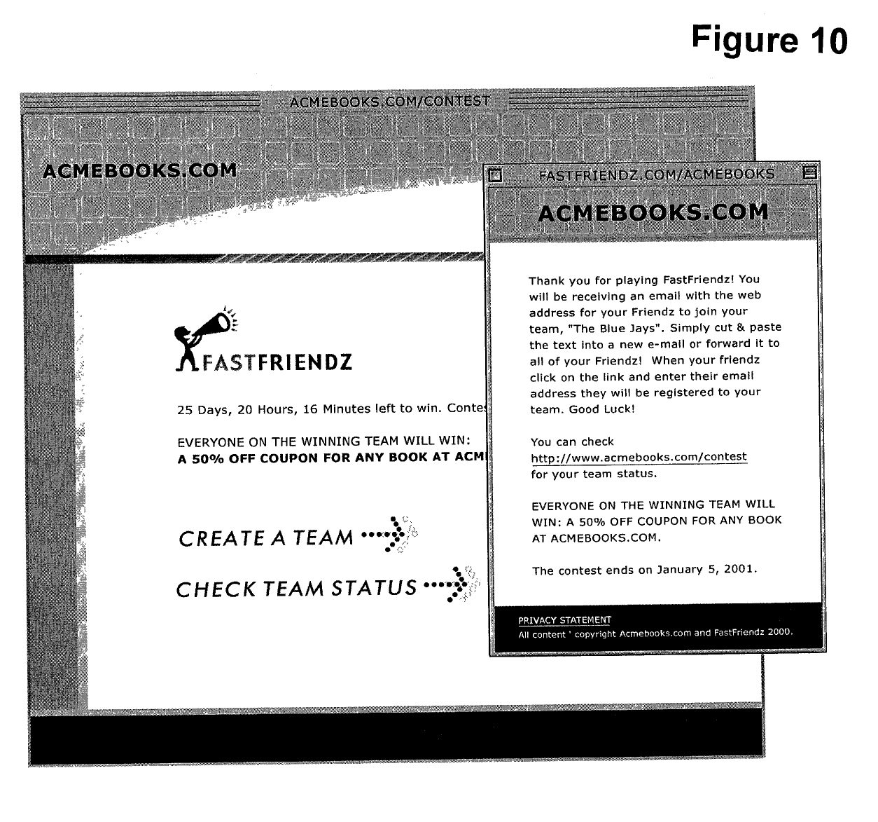

Once the friend has entered the required information into the data fields, the system displays the pop-up window shown in FIG. 10. This pop-up window confirms the friend's enrollment in the team and provides the friend with further information about the game. For instance, the pop-up window can inform the friend that the system will send an email with which the friend can continue the email string. The pop-up window can also provide the URL at which to check team standings, and can reiterate the prize and the game deadline. At this point, the friend can close the pop-up window, return to the web site of the sponsor, and continue browsing.

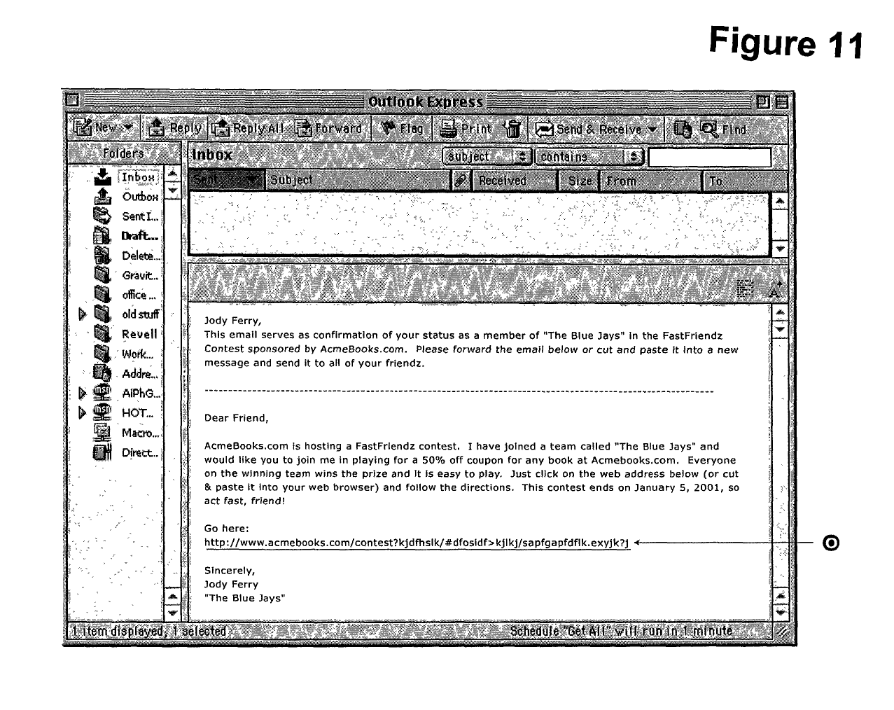

FIG. 11 shows the email sent by the system to the newly enrolled friend. The email confirms the newly enrolled friend's status as a member of the team (which is named “The Blue Jays” in this example). The email also includes instructions on how to continue the email string, and preferably includes a prepared email message that the newly enrolled friend can readily forward to more friends (potential players). The newly enrolled friend can simply forward the prepared email message or can cut and paste the message into a new message. The prepared email message includes an encrypted uniform resource locator O that passes the name of the newly enrolled friend, the team name, the URL for the host site (in the background), and the URL for the pop-up window of the game administrator (in the forefront).

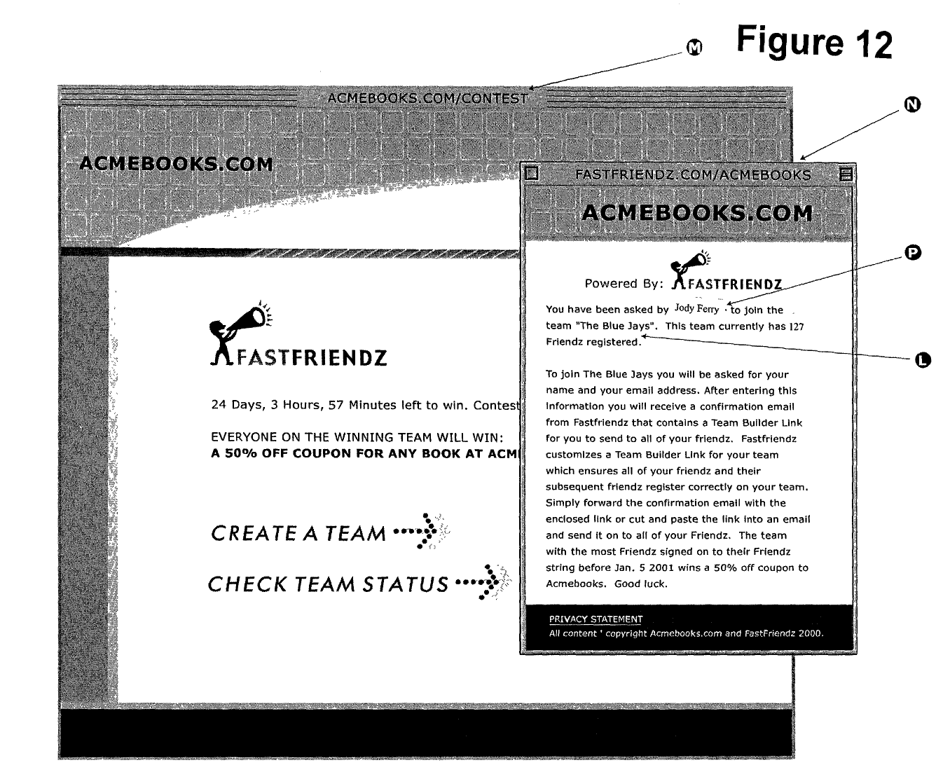

After the newly enrolled friend (whose name in this example is Jody Ferry) forwards the email to a second friend and the second friend clicks on the encrypted URL in the message, the system opens the contest page of the sponsor web site in the background with the pop-up window of the game administrator in front, as shown in FIG. 12. The encrypted URL passes the information for these windows M and N, as well as the referring player's name P and the team name L, which in this example are Jody Ferry and The Blue Jays, respectively. The pop-window N provides the second friend (potential player) with information about the team and the game. For example, the pop-up window provides the name of the team, the name of the referring player, the number of enrolled members on the team, and instructions on how to join the team and play the game.

The process shown in FIGS. 8-12 for extending the email string and enrolling members repeats for other friends (potential players) until the game ends, as dictated by the game deadline.

Once a player has enrolled in a team, the player can check the team's status at any point during or after the game. To check a team, the player visits the web site of the game administrator or sponsor, which presents the page having the options “create a team” and “check team status” (as shown in FIG. 3). If the player tries to create a team with the same email the player used to join a team, the system returns a message such as the following: “You are already enrolled in this FastFriendz contest sponsored by Acmebooks.com. To see a list of other contests currently being held, please visit FastFriendz.com.”

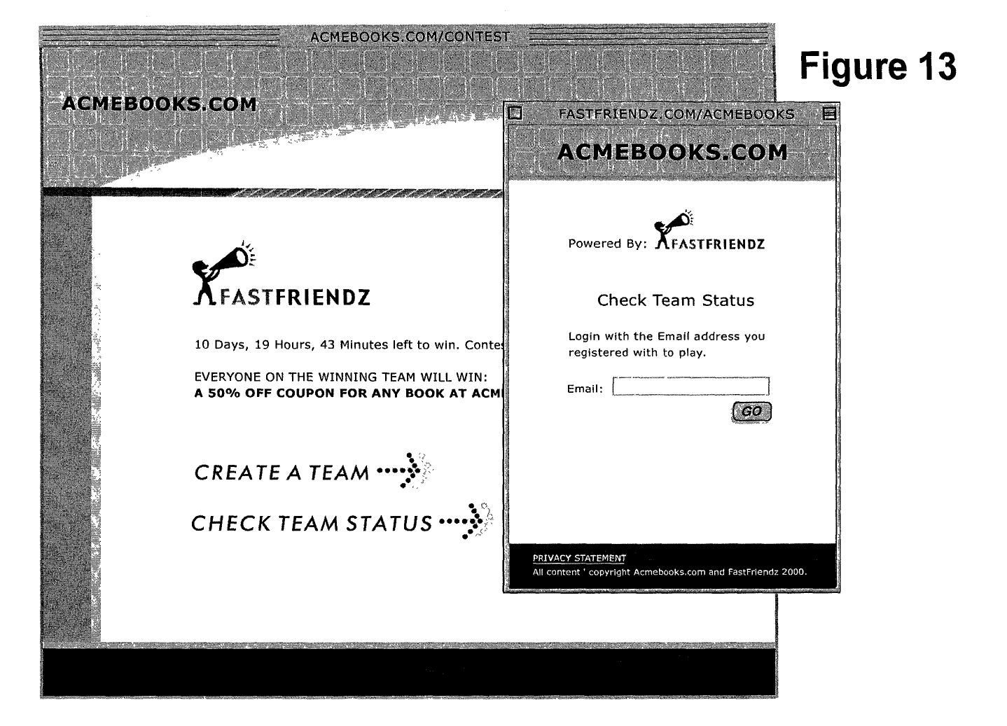

If the player chooses the “check team status” option, then the system displays the pop-up window shown in FIG. 13, which prompts the player for the email address the player used to enroll in the team. If the player provides an email address that has not been used to enter the contest that they are inquiring about, then the system returns a message such as the following: “This email address has not been used to play this FastFriendz contest. Please click the appropriate link below:

I must have misspelled my email address. I would like to enter it again <back to prompt>

I have not joined a FastFriendz team. I would like to start my own team <goto team creation>

I have not joined a FastFriendz team. I have no desire to win a 50% off coupon on any book at Acmebooks.com and would like to close this window.”

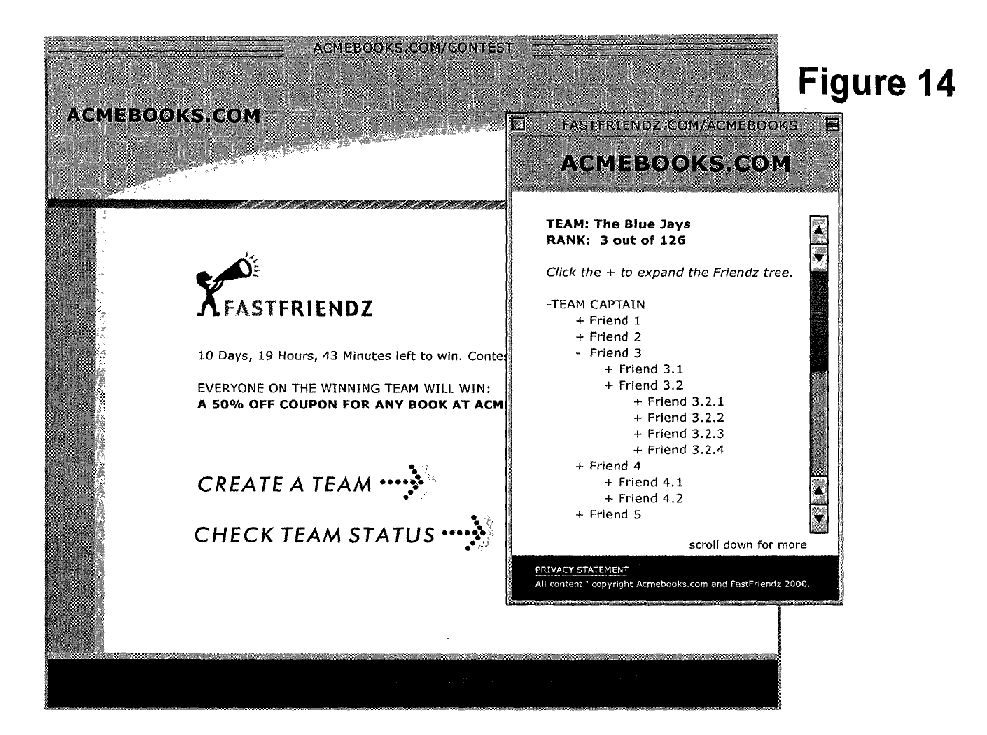

If the player does enter a valid email address in the pop-up window of FIG. 13, then the system displays the pop-window shown in FIG. 14. This pop-up window provides information about the status of the player's team, such as the team name, the rank of the team as compared to other teams, and a representation of the string of players. The representation could be, for example, a tree as shown in FIG. 14. This tree consists of a list in the style of a file directory, which can be expanded or contracted to show the relationships through which team members have been enrolled. For instance, in the example of FIG. 14, Friend 3 referred Friend 3.2, who in turn referred Friend 3.2.1, Friend 3.2.2, Friend 3.2.3, and Friend 3.2.4. In an alternate embodiment of the present invention, instead of giving a uniform prize to all team members, these relationships can be the basis for awarding different prizes to the winning team members. For example, like a pyramid scheme, players who refer more team members earn a larger prize.

As another example of the representation of the string of players, the system could provide a specially designed overhead view of the player string. The view could resemble a road map or tree that would grow as members enrolled in the team. All player names could appear as street signs or branch names, marking how many members enrolled before them and after them. This view could be scrollable to accommodate any size necessary.

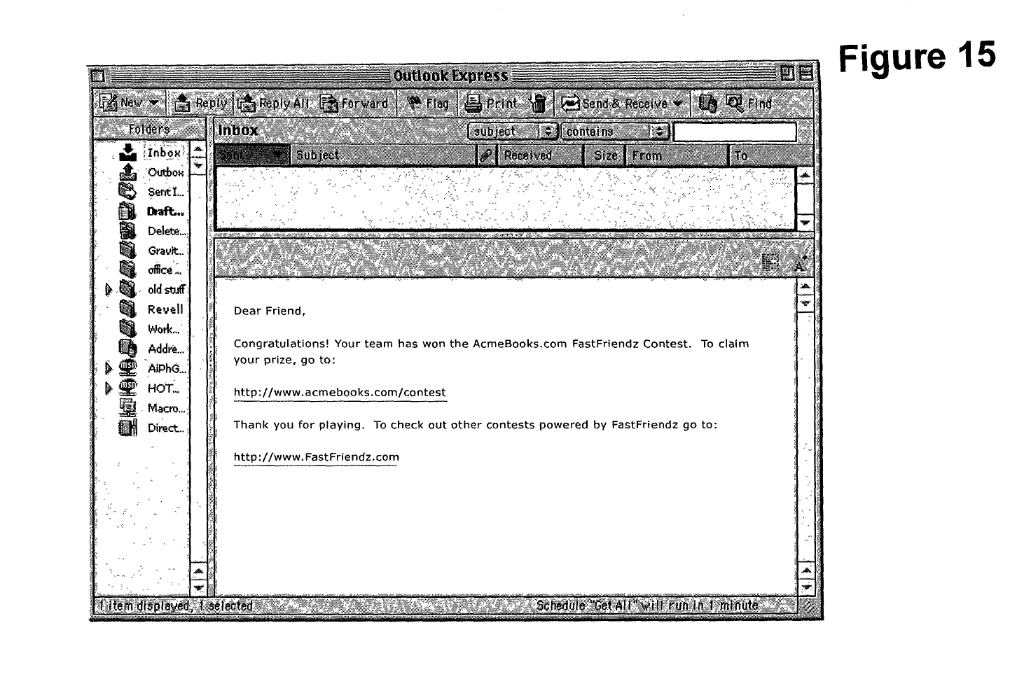

At the conclusion of a game, the system sends an email to the members of the winning team, as shown in FIG. 15. In addition to informing the members of their success, the email also preferably includes a link to claim the prize at the sponsor's web site and a link to visit the web site of the game administrator to browse more games. This email provides another opportunity to push advertising content to the participants, either in the email itself or through the links.

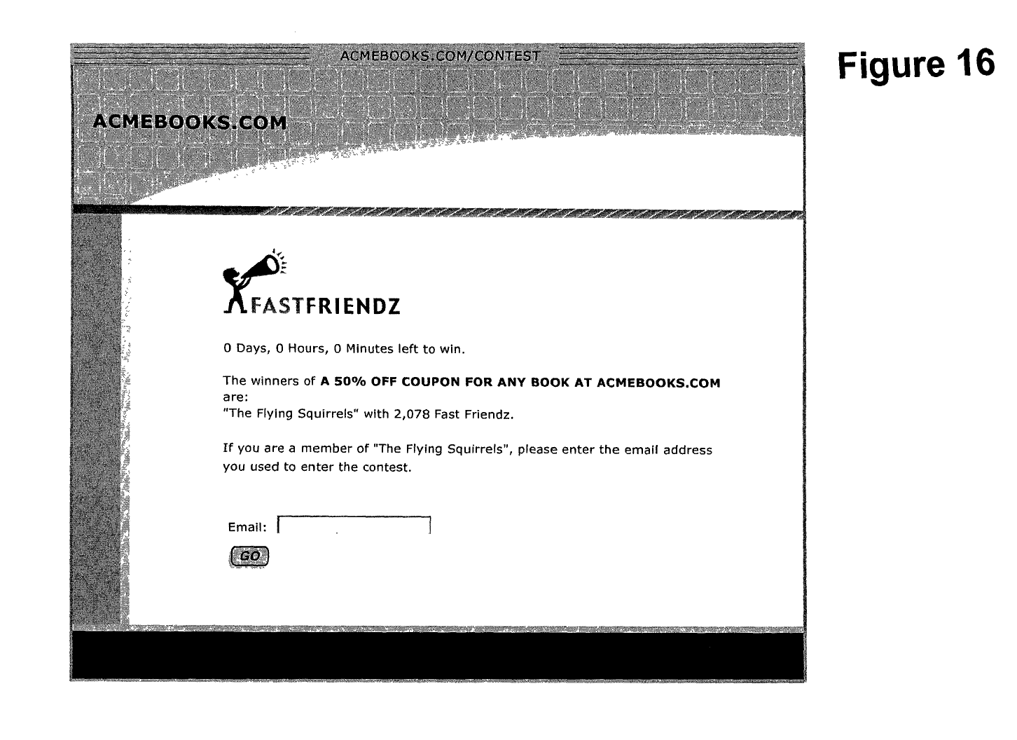

When the winning team members click through the link to the sponsor's web site, the system displays the page shown in FIG. 16. The page provides information about the game and about claiming the prize. For example, the page could include the name of the winning team, the number of enrolled members on the winning team, and the prize that the enrolled members have won. The page preferably prompts the winning members for their email address to claim their prizes. Again, this page provides another opportunity for the sponsor to push additional advertising content to the participants.

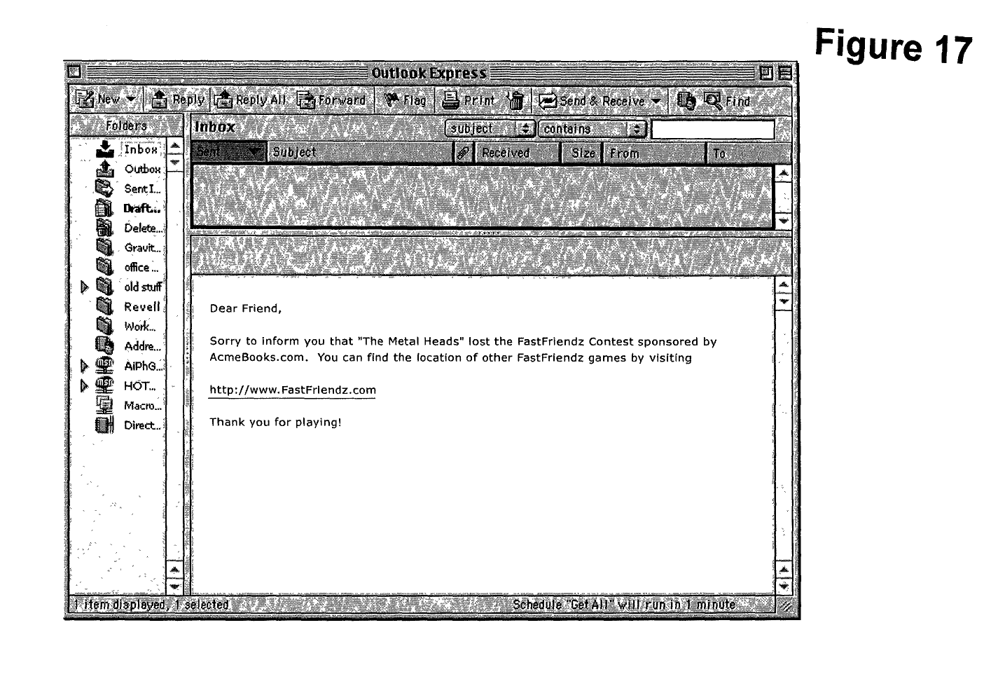

Finally, FIG. 17 illustrates an email that the system sends to enrolled members of losing teams. These members agreed to receive such an email upon enrollment, and would be receptive to opening the email to see if they won. The email includes information about the winning team and about entering other games (for example, by clicking through a link to the web site of the game administrator). Once again, this email provides another opportunity to display advertising.

Tracking enrolled members is an important aspect of the present invention. Included in this tracking is the association of members with a team and with other enrolled members. The encrypted URL, described above, is one way to accomplish this tracking. The generation of the encrypted URL depends on the programming language used to build the system. However, as a general rule, the end of a URL string includes information in the form of variables (for example, a URL string might look like http://www.acmebooks.com/contest.cfm?player_id=23&team_id=17&popup=1 before it is encrypted). These variables correspond to values stored in the database. When the URL is opened in a browser, the programming on that page reads the variables, retrieves the stored information in the database (for example, as annotated in J and O of FIGS. 7 and 11), and displays the information where it is programmed to do so.

(To prevent users from entering alternate ID numbers, the URL is encrypted so that only the server of the game administrator and the corresponding web page understand the data. This method makes the URL difficult to “crack” and get information about other enrolled members. The URL is encrypted after it is created and unencrypted by the actual web page.

Although the representative embodiment of the present invention describes the use of encrypted URLs to accomplish member tracking, one of ordinary skill in the art would appreciate that other methods are possible, such as techniques using cookies. With any method, however, the goals of tracking include recognizing returning players, preventing attempted multiple entries, and ensuring that enrolled members are correctly associated with their team and with other enrolled members of that team.

In gathering information about players, the present invention stores data in databases 102, 103, and 104 of FIG. 1. Preferably, the data is stored in tables of the databases. As described above, all player information (excluding demographics information) is stored in player database 104. Thus, after a player has completed the sign-up process and provided his information, subsequent pages, such as the confirmation page shown in FIG. 6, can encrypt the URL with the information just provided. Likewise, the email is a template of variables drawn from the information stored in the player database 104. Upon creation of the email, these variables are populated with actual values that are pulled from player database 104. The URL is created with variables as well, is encrypted, and is then inserted into the email. These actions take place on what is known as an “action page,” which contains the programming necessary to execute these functions.

The pop-up windows described above for the game flow of FIGS. 3-17 appear when a variable is passed to the host page that instructs the host page to launch the pop-up window. For instance, http://www.acmebooks.com/contest.cfm?popup=1 makes the pop-up window appear, but http://www.acmebooks.com/contest.cfm?popup=0 does not. An example of a programming language suitable for the examples described herein is ColdFusion™.

In an alternate embodiment of the present invention, the prize for a game includes cash payouts to winning team members, therefore requiring person-to-person payment from the sponsor to the winning team members. Technologies and services that accomplish this payment scheme are well known in the art. Because all players must have email, they are eligible to receive payment through email. This payment scheme also allows an additional crosscheck against individuals having duplicate enrollments in the same team (using more than one email address) and duplicate enrollments in more than one team in the same contest.

### Benefits

The present invention provides significant benefits to players, sponsors, and game administrators. For players, the immediate benefit is the enjoyment of competing in a game for a prize. The game is free and is easy to play. In addition, by branching out to friends of friends, the game can build a community among friends. People may run across friends that they have not spoken to in years or may reconnect with friends with whom they have lost contact. The present invention facilitates easy communication with friends, providing a group email command feature by which a player can email all enrolled members of the player's team. In building the team, the present invention allows a player to cut and paste his entire email address book and to send one email out to all of his friends. This ease of use is important to assure the maximum spread of the encrypted URL.

Also, for players, the present invention appeals to the growing popularity of email. Email solicitations to play the game come from known email addresses of friends. This critical aspect sets the solicitation of the present invention apart from the spam that permeates email marketing. By using an email address familiar to the recipient, the chance that a recipient will open the email and view the advertisement of the sponsor is greatly increased.

The email comes from a friend and can even include a custom introduction written by the friend. The game administrator provides a customized link that ensures that the recipient enrolls in the correct team and that no team cheats with bogus emails or phantom friends.

To protect the privacy of players, the only time the game administrator learns who received a player's email is when a friend of that player agrees to join the player's team. At that time, the game administrator adds the name of the friend to the team. The game administrator and the sponsor do not know whom a player asks to join his team.

Also, for the benefit of the players, the game administrator preferably maintains a privacy policy according to which the email addresses and enrollment information of players are the shared confidential property of the game administrator and the sponsor. In addition, the game administrator reserves the right to send a follow up email to all participants asking if they would like additional information about partners of the game administrator. In this email, players have the option of opting out of any future email correspondence from the game administrator.

For sponsors and game administrators, an important aspect of the present invention is its ability to gather valuable customer data. The data submitted by players is preferably jointly owned by a sponsor and a game administrator. The data is stored on the databases of the game administrator. The sponsor has password access to the data stored for its game. The game administrator, however, has access to data from all games played for all sponsors.

For sponsors, the present invention also offers a unique way to create page views. By loading a page of the host web site behind the pop-up windows, the invention enables a host and its advertisers to expose their products and services to potential customers. Thus, the present invention drives customers to host web sites and increases web site traffic and sales.

In addition, the present invention provides a unique way to learn more about the customers and potential customers of sponsors. By capturing player email addresses and collecting answers to pointed survey questions, sponsors can learn more about the users who visit their sites. As a result, the sponsors can identify common interests among users and can structure marketing efforts that cater to those interests. Each host web site has the ability to specify questions to ask during the enrollment process. Therefore, each sponsor can structure the game to meet its particular marketing goals.

For example, if the sponsor wishes simply to increase page views for its web site, then the survey questions can be simple inquiries about personal information, such as name and gender. If the sponsor wishes to capture demographic information, then the questions must obtain detailed information about the players. For example, the questions could ask about age, gender, level of education, amount of Internet usage per week, and favorite brand of soda. In the end, however, the customized questionnaire feature of the present invention allows each sponsor to use the administrative back end capabilities of the game to adjust the game to the particular needs of the sponsor.

Through interest generated by the game, the present invention also increases web traffic among and return visits to sponsor web sites. The spirit of competition encourages players to frequently check the contest page of the host web site to review the status of their team in relation to other teams. The competition therefore creates a “stickiness” for the sponsor web site, increasing exposure of the sponsor's products and/or services.

In describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, unless that order is explicitly described as required by the description of the process in the specification. Otherwise, one skilled in the art can readily appreciate that the sequences may be varied and still remain within the spirit and scope of the present invention.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims, and by their equivalents.

I claim:

1. An electronic game in which a plurality of remotely located players participate, the game comprising of: (a) means for recording game activities on game administrator servers; (b) means to uniquely identify game players; (c) means to generate email template for players to email game details to additional players inviting them to play the game; and (d) means for determining a winner.

2. An electronic game as recited in claim 1 wherein the game comprises database activities that reside on game administrator servers.

3. An electronic game as recited in claim 2 wherein the system architecture is based on an application service provider model.

4. An electronic game as recited in claim 1 wherein game administrator servers customize uniform resource locator addresses to uniquely identify individual players who create teams: and to uniquely identify the subsequent additions to the teams.

5. An electronic mail game as recited in claim 1 wherein game administrator servers record all player entries.

6. An electronic game as recited in claim 1 wherein game administrator servers measure the size in numbers of players on teams.

7. An electronic game as recited in claim 2 wherein database records players creating teams intending to participate in the game.

8. An electronic game as recited in claim 1 wherein players access host web site using a personal computer in communication with host web site through a global information network such as the Internet; and host web site in communication with game administrator servers.

9. An electronic game as recited in claim 1 wherein game administrator servers utilize encryption to generate a unique uniform resource locator address that players receive in an email response from the game administrator server.

10. An electronic game as recited in claim 4 wherein the coding of the uniform resource locator address includes coded data identifying the first player as the creator of the team.

11. An electronic game as recited in claim 2 wherein game administrator servers store information submitted by participating players: records that the first player receives credit for all supplemental players that joined the game in response to an email message sent by first player: records all players responding to an email message sent by players invited by first player; and records all entries submitted by subsequent players that were connected via an email string from the first player.

12. An electronic game as recited in claim 1 wherein the game administrator servers store all player entries within specified game time period.

13. An electronic game as recited in claim 6 wherein the game administrator servers determines the winner by measuring the size of teams in terms of numbers of players: identifying the largest team as winners.

14. A method of providing an electronic mail game comprising the steps of: utilizing an application service provider model to administer said game; accepting an electronic application to play game, via personal computer and the Internet and a browser on the world wide web; delivering said user an electronic mail confirmation of application; approving application by verifying valid email address; providing electronic mail response that can be forwarded as invitations to said users friends to join said team; administering said friends replicating said electronic mail invitations from said friends to said friend's friends; and said electronic mail game providing an entertaining game that attracts players.

15. The method of providing an electronic mail game as claimed in 14, wherein the method validates electronic mail addresses by recording the opening of the confirmation email sent to the applying player.

16. The method of providing an electronic mail game as claimed in 14, wherein encrypted uniform resource locators contain customized data for each team: said uniform resource locator ensures that each player joins the team created by said user; and said uniform resource locator ensures said friends join only one team per specified game period.

17. The method of providing an electronic mail game as claimed in 14, wherein said user utilizes electronic mail to distribute invitations to play said game; and said invitation appears to the recipient as an electronic mail message from said user.

18. The method of providing an electronic mail game as claimed in 14, wherein said user may customize said electronic mail invitation with a typewritten textual message that appears within said electronic mail invitation.

19. The method of providing an electronic game as claimed in 14 wherein, a host web site presents the game to a user through a graphical user interface, the end user accesses host web site using a personal computer in communication with the host web site through a global information network such as the Internet; and host web site is in communication with game administrator server through a network connection.

20. A method of delivering advertising within an electronic game the method comprising steps of: (a) including advertisements within the email confirmation sent to participating game players; (b) including advertisements within the email that game players forward via email; (c) including advertising within email sent to all game players for notification of winners; and (d) utilizing game players to distribute advertising messages via electronic mail.
